(19) United States
(12) Patent Application Publication
(10) Pub. No.: US 2025/0259799 A1
(43) Pub. Date: Aug. 14, 2025

(54) SOLID ELECTROLYTIC CAPACITOR

(71) Applicant: Panasonic Intellectual Property Management Co., Ltd., Osaka (JP)

(72) Inventors: MASATOSHI TAKESHITA, Osaka (JP); RIE OKAMOTO, Osaka (JP); KOHEI GOTO, Osaka (JP)

(21) Appl. No.: 19/195,717

(22) Filed: Apr. 30, 2025

Related U.S. Application Data
(63) Continuation of application No. PCT/JP2023/041322, filed on Nov. 16, 2023.

(30) Foreign Application Priority Data
Nov. 25, 2022 (JP) 2022-188438

(51) Int. Cl. H01G 9/025; H01G 9/045; H01G 9/15; H01G 9/26

(52) U.S. Cl. CPC H01G 9/025; H01G 9/045; H01G 9/15; H01G 9/26

(57) ABSTRACT

The solid electrolytic capacitor includes at least one capacitor element. The at least one capacitor element includes an anode foil including a porous part at least in a surface layer of the anode foil, a dielectric layer covering at least a part of the anode foil, and a solid electrolyte layer covering at least a part of the dielectric layer. The solid electrolyte layer contains a first polymer component containing a conjugated polymer, and a second polymer component containing a polymer anion. In a Raman spectrum of a surface layer of the solid electrolyte layer, a peak that is characteristic to the first polymer component is observed. An average thickness T (nm) of the dielectric layer is more than or equal to 2.5×Rv, where Rv (V) represents a rated voltage of the solid electrolytic capacitor.

### BACKGROUND

### 1. Technical Field

The present disclosure relates to a solid electrolytic capacitor.

### 2. Description of the Related Art

A solid electrolytic capacitor includes a solid electrolytic capacitor element, a resin exterior body or a case that seals the solid electrolytic capacitor element, and an external electrode electrically connected to the solid electrolytic capacitor element. The solid electrolytic capacitor element includes an anode body, a dielectric layer formed on a surface of the anode body, and a cathode part that covers at least a part of the dielectric layer, for example. The cathode part includes a conductive polymer (e.g., a conjugated polymer and a dopant) that covers at least a part of the dielectric layer. The conductive polymer is also referred to as a solid electrolyte.

The solid electrolyte can be formed using in situ polymerization such as chemical polymerization or electrolytic polymerization. However, from the viewpoint of simplifying formation of solid electrolyte, solid electrolyte is often formed using a method that uses a liquid dispersion that contains a conjugated polymer and a dopant.

For example, Unexamined Japanese Patent Publication No. 2013-58807 discloses a method for manufacturing an electrolytic capacitor including a step of impregnating an anode body provided with a dielectric film on a surface of the anode body, with a first dispersion solution containing particles of a first conductive polymer and a first solvent, and then impregnating the anode body with a second dispersion solution containing particles of a second conductive polymer and a second solvent, where a pH of the first dispersion solution is closer to 7 than a pH of the second dispersion solution.

### SUMMARY

One aspect of the present disclosure relates to a solid electrolytic capacitor including at least one capacitor element. The at least one capacitor element includes an anode foil including a porous part at least in a surface layer of the anode foil, a dielectric layer covering at least a part of the anode foil, and a solid electrolyte layer covering at least a part of the dielectric layer. The solid electrolyte layer contains a first polymer component containing a conjugated polymer, and a second polymer component containing a polymer anion. In a Raman spectrum of the surface layer of the solid electrolyte layer, a peak that is characteristic to the first polymer component is observed. An average thickness T (nm) of the dielectric layer is more than or equal to 2.50×Rv, where Rv (V) represents a rated voltage of the solid electrolytic capacitor.

The present disclosure provides a solid electrolytic capacitor having high charging and discharging characteristics and a high withstand voltage.

### BRIEF DESCRIPTION OF THE DRAWINGS

FIG. 1 is a schematic sectional view illustrating a solid electrolytic capacitor according to an exemplary embodiment of the present disclosure.

### DETAILED DESCRIPTIONS OF EMBODIMENTS

Prior to the description of an exemplary embodiment, problems in the related art will be briefly described.

In the solid electrolytic capacitor, from the viewpoint of ensuring a high capacitance, a porous part is provided in at least a surface layer of the anode body. By using a liquid dispersion containing a conductive polymer, a relatively thick solid electrolyte layer can be formed, and thus is advantageous in ensuring a high withstand voltage. However, when the liquid dispersion is used, it becomes difficult to fill the voids of the porous part with the conductive polymer. Hence, it becomes difficult to achieve high adhesiveness between the anode body and the solid electrolyte layer, and between an inner layer formed inside the void and an outer layer formed outside the porous part. Therefore, the amount of capacitance drop due to repeated charging and discharging of the solid electrolytic capacitor increases, and it becomes difficult to achieve excellent charging and discharging characteristics.

When the solid electrolyte layer is formed by electrolytic polymerization, the voids in the porous part can be better filled, and better charging and discharging characteristics can be achieved. However, in some cases, it is not possible to ensure a high withstand voltage.

In the solid electrolyte layer formed by the electrolytic polymerization, the conjugated polymer and the dopant are uniformly distributed, as compared with the solid electrolyte layer formed using the liquid dispersion. Hence, high electron conductivity in the solid electrolyte layer can be achieved with the electrolytic polymerization. Further, an increase in resistance of the solid electrolyte layer, which is caused by segregation of the polymer anion, can be suppressed. As a result, a low equivalent series resistance (ESR) and excellent cycle characteristics can be achieved. However, it has been found that the breakdown voltage is low with the solid electrolyte layer formed by the electrolytic polymerization.

### Technology 1

In view of the above, a solid electrolytic capacitor according to one aspect of the present disclosure includes at least one capacitor element. The at least one capacitor element includes an anode foil including a porous part on at least a surface layer of the anode foil, a dielectric layer covering at least a part of the anode foil, and a solid electrolyte layer covering at least a part of the dielectric layer. The solid electrolyte layer includes a first polymer component containing a conjugated polymer, and a second polymer component containing a polymer anion. In a Raman spectrum of the surface layer of the solid electrolyte layer, a peak that is characteristic to the first polymer component is observed. An average thickness T (unit: nm) of the dielectric layer is more than or equal to 2.50×Rv, where Rv (unit: V) represents a rated voltage of the solid electrolytic capacitor.

In the configuration described above (Technology 1), by setting the average thickness T of the dielectric layer to 2.50 times or more the rated voltage of the solid electrolytic capacitor, it is possible to improve the breakdown voltage of a solid electrolyte layer formed by electrolytic polymerization, and to ensure a high withstand voltage. In general, there is a tendency that the capacitance of the solid electrolytic capacitor decreases as the thickness of the dielectric layer is increased. However, in the solid electrolytic capacitor according to the present disclosure, by forming the solid electrolyte layer by electrolytic polymerization, a decrease in capacitance due to an increased thickness of the dielectric layer is compensated, and thus a sufficiently high capacitance can be achieved. Furthermore, a decrease in capacitance is suppressed even when the solid electrolytic capacitor is charged and discharged repeatedly. Even with a capacitor with a rated voltage more than or equal to 12 V, which is generally considered as a high voltage, a breakdown resultant of the application of the voltage can be suppressed.

### Technology 2

In the configuration according to (Technology 1), the solid electrolyte layer may contain sulfur (S) element, and the anode foil may contain aluminum (Al) element. The solid electrolyte layer includes a first part and a second part. The first part fills voids of the porous part of the anode foil provided with the dielectric layer. The second part is disposed outside from a principal surface of the anode foil provided with the dielectric layer. In element mapping of a cross section of the porous part, the element mapping being obtained using an electron probe micro analyzer (EPMA), an abundance ratio of S element in the porous part may be more than or equal to 0.5% in setting an abundance ratio of Al element in the porous part to be 100%. With this, it is possible to further suppress a decrease in capacitance when the solid electrolytic capacitor is charged and discharged repeatedly.

The S element is mainly derived from the conjugated polymer and the dopant contained in the solid electrolyte. For example, a polythiophene-based conjugated polymer includes S element in a thiophene ring, and the dopant includes an S element derived from an anionic group such as a sulfo group. The anode foil containing Al element is mainly of aluminum or an aluminum alloy, and the dielectric layer is made of aluminum oxide. Therefore, the abundance ratio of the S element being relatively high with respect to the abundance ratio of Al element in the porous part means that the ratio of the solid electrolyte contained in the porous part being relatively high (in other words, the voids of the porous part are filled with the solid electrolyte at a higher packing density). In the present disclosure, by ensuring that the abundance ratio of the S element in the porous part is within the range mentioned above, a relatively high packing density of the solid electrolyte is ensured, so that it is possible to reduce the paths for air flows, and to inhibit the progress of deterioration of the solid electrolyte. Furthermore, since the voids in the porous part are filled highly densely with the solid electrolyte, it is possible to maintain a relatively large number of contact points between the first part and the second part or between the porous part and the second part, even when the volume of the solid electrolyte changes repeatedly as a result of the solid electrolyte capacitor being charged and discharged repeatedly. Therefore, it is possible to maintain a relatively high capacitance even when the solid electrolyte capacitor is charged and discharged repeatedly.

Such a relatively high content of the S element in the porous part is achieved by, for example, forming a dielectric layer on a surface of an anode foil containing Al element and having a porous part at least on a surface layer of the anode foil; immersing the anode foil provided with the dielectric layer formed on the surface, in a polymerization liquid containing a precursor of a conjugated polymer and a polymer anion containing S element; and electrolytically polymerizing the anode foil at a relatively low polymerization potential in a three-pole electrolytic polymerization. By carrying out the electrolytic polymerization under such specific conditions, the precursor of the conjugated polymer is allowed to gradually polymerize with the presence of the polymer anion that is relatively stable as a dopant, and a conductive polymer is formed as a result of interaction between the conjugated polymer and the polymer anion. In this manner, a dense solid electrolyte is formed. Because the precursor and the polymer anion are dissolved in the polymerization liquid, the precursor and the polymer anion are allowed to go deeply into the fine voids of the porous part. Therefore, polymerization takes place not only in the vicinity of the opening of the voids but also deep inside the void. Hence, the voids can be filled with the solid electrolyte at a high packing density. Inside the voids of the porous part, the precursor of the conjugated polymer goes through polymerization while interacting with the polymer anion, so that it is possible to achieve a highly oriented conjugated polymer with the polymer anion uniformly distributed. In this manner, there is a tendency that high doping concentration can be achieved. Hence, the conductivity of the solid electrolyte in the first part can be improved, and dedoping or deterioration of the conjugated polymer can be suppressed even when the solid electrolyte capacitor is charged and discharged repeatedly. Furthermore, since the porous part is filled with the solid electrolyte at a high packing density, a relatively large number of contact points are maintained between the first part or the porous part and the second part, even when the volume of the solid electrolyte changes repeatedly as a result of repeated charging and discharging of the solid electrolyte capacitor. Therefore, excellent advantages such as those described above can be achieved.

When the first part is formed using a liquid dispersion that contains a conjugated polymer such as poly (3,4-ethylenedioxythiophene) (PEDOT) containing S element, and a polymer anion such as polystyrene sulfonic acid (PSS) including S element, the abundance ratio of the S element in the porous part remains low, e.g., below 0.5%. It is considered that this is because the packing density of the porous part with the solid electrolyte is low with the use of a liquid dispersion.

The three-pole electrolytic polymerization is carried out using three electrodes of a counter electrode, a reference electrode, and an anode foil provided with a dielectric layer formed on a surface. With the three-pole electrolytic polymerization, the potential of the anode can be controlled precisely using the reference electrode, without being affected by a change in the natural potential of the counter electrode. With the three poles, the electrolytic polymerization reaction is controlled more precisely than in the two-pole polymerization that uses the anode foil and the counter electrode. Furthermore, by setting the polymerization potential within a predetermined range, the polymer chain grows slowly while interacting with the polymer anion. Therefore, the conjugated polymer thus formed has high orientation and includes the uniformly distributed polymer anion. Hence, a more uniform and denser solid electrolyte is formed inside the voids of the porous part, at a high packing density. Further, since the polymer anion is uniformly distributed, it is possible to achieve a relatively high doping concentration, and thus the conductivity itself of the solid electrolyte can be improved.

### Technology 3

In the configuration according to (Technology 1) or (Technology 2) described above, the average thickness T (nm) of the dielectric layer may be less than or equal to 3.5×Rv. In this case, a higher capacitance can be achieved.

### Technology 4

In the configuration according to any one of (Technology 1) to (Technology 3), the rated voltage Rv of the solid electrolytic capacitor may be more than or equal to 12 V. According to the present disclosure, it is possible to obtain a solid electrolytic capacitor capable of tolerating high-voltage uses, in which rated voltages are high.

### Technology 5

In the configuration according to any one of (Technology 1) to (Technology 4), the conjugated polymer may contain a monomer unit corresponding to a thiophene compound. In such a case, by adjusting the conditions of the electrolytic polymerization, the electrolytic polymerization is promoted even in the presence of the polymer anion containing the S element. This is advantageous in improving the packing density of the conductive polymer in the voids of the porous part.

### Technology 6

In the configuration according to (Technology 5), the peak that is characteristic to the first polymer component may include a first peak observed in a wavenumber range from 1200 cm⁻¹ to 1600 cm⁻¹, inclusive. The first peak is attributed to the C═C stretching vibration of the thiophene ring in the monomer unit corresponding to the thiophene compound. With the clearly observable first peak, it can be recognized that segregation of the polymer anions is suppressed. Because the conjugated polymer and the polymer anion are uniformly distributed across the solid electrolyte layer, higher charging and discharging characteristics can be achieved.

### Technology 7

In the configuration according to (Technology 5) or (Technology 6), the first polymer component may contain at least a monomer unit corresponding to a 3,4-ethylenedioxythiophene compound, as the monomer unit corresponding to the thiophene compound. With this, it is possible to better achieve a higher conductivity in the solid electrolyte layer, and to achieve higher charging and discharging characteristics.

### Technology 8

In the configuration according to any one of (Technology 1) to (Technology 7), a weight average molecular weight Mw of the polymer anion may be in a range from 100 to 500,000, inclusive. With this, there is a tendency that higher dispersibility of the polymer anion and a relatively high doping concentration are achieved in the first part. This setting is therefore advantageous in ensuring a higher conductivity of the solid electrolyte layer. In addition, there is a tendency that highly stable dopant and the solid electrolyte are achieved.

### Technology 9

The polymer anion may contain a monomer unit corresponding to an organic sulfonic acid compound. Even when used is such polymer anion, since the porous part can be densely filled with the solid electrolyte, there is a tendency that highly conductive solid electrolyte layer is obtained, and that a relatively high capacitance is maintained even when the electrolytic capacitor is charged and discharged repeatedly.

### Technology 10

In the configuration according to any one of (Technology 1) to (Technology 9), the peak that is characteristic to the first polymer component may include a first peak observed in a wavenumber range from 1200 cm⁻¹ to 1600 cm⁻¹, inclusive. The polymer anion may contain a monomer unit corresponding to an aromatic sulfonic acid compound. In a Raman spectrum of the surface layer of the solid electrolyte layer, a second peak that is characteristic to the second polymer component may be observed in a wavenumber range from 800 cm⁻¹ to 1100 cm⁻¹, inclusive. A ratio Iₚ₁/Iₚ₂ of an intensity Iₚ₁ of the first peak with respect to an intensity Iₚ₂ of the second peak may be more than or equal to 2. When the ratio Iₚ₁/Iₚ₂ is within such a range, the conjugated polymer in the second part exhibits relatively high orientation and crystallinity. Therefore, a higher conductivity can be ensured in the solid electrolyte of the second part.

### Technology 11

In any one of the configurations according to (Technology 2) and the configurations according to (Technology 3) to (Technology 10) that are dependent on (Technology 2) described above, in the Raman spectrum of the first part, a ratio Iₚ₁/Iₚ₂ of the intensity Iₚ₁ of the first peak that is characteristic to the first polymer component with respect to the intensity Iₚ₂ of the second peak that is characteristic to the second polymer component may be more than or equal to 2. When the ratio Iₚ₁/Iₚ₂ is within such a range, the conjugated polymer in the first part exhibits relatively high orientation and crystallinity. Therefore, a higher conductivity can be achieved in the solid electrolyte of the first part.

### Technology 12

In the configuration according to any one of (Technology 1) to (Technology 11), the solid electrolytic capacitor may include a plurality of capacitor elements that are stacked. With this, it is possible to achieve a higher capacitance. Further, since a packing density of the solid electrolyte in the voids of the porous part is higher, a high capacitance can be maintained even when the electrolyte capacitor is charged and discharged repeatedly.

The solid electrolytic capacitor according to the present disclosure, including the configurations according to (Technology 1) to (Technology 12) described above, will be now described more specifically. At least one selected from the components to be described below may be combined with at least one of the above-described configurations according to (Technology 1) to (Technology 12) that are pertinent to the solid electrolytic capacitor according to the present disclosure, as long as such combinations are technically possible.

### Solid Electrolytic Capacitor

A solid electrolytic capacitor includes one, or two or more capacitor elements.

### Capacitor Element

A capacitor element includes an anode foil, a dielectric layer covering at least part of the anode foil, and a cathode part covering at least a part of the dielectric layer. The cathode part includes a solid electrolyte layer covering at least a part of the dielectric layer.

### Anode Foil

The anode foil included in the capacitor element may contain, for example, a valve metal, an alloy including a valve metal, and a compound including a valve metal. The anode foil may contain one kind of these materials, or two or more kinds in combination. Examples of the valve metal include aluminum (Al), tantalum, niobium, and titanium. The anode foil may contain at least aluminum. The anode foil may contain an aluminum metal, an aluminum alloy, or both.

The anode foil has a porous part at least on a surface layer. The porous part includes many fine voids. With the porous part, the anode foil has extremely small dents and bumps at least on the surface. In this manner, the surface area is increased, so that a high capacitance can be obtained. The porous part can be formed by roughening the surface of a metal foil, for example. Such an anode foil may include a core part and a porous part that is formed on each of the both sides of the core part, and is continuous to the core part. The porous part is a roughened outer part of the metal foil, and the remaining part that is an inner part of the metal foil is the core part. The porous part may be formed on a part of the surface layer of the anode foil, or may be formed across the entire surface layer.

The roughening may be performed by etching treatment, for example. The etching treatment may be electrolytic etching or chemical etching. For example, with electrolytic etching, the thickness of the porous part, the shape and size of the voids, and the like may be adjusted using the etching conditions (e.g., the number of steps of and the time of the etching treatment, the current density, or the composition and the temperature of the etching solution), for example.

The anode foil includes a first end and a second end that is on the opposite side of the first end. The solid electrolyte layer is formed on a part of the anode foil, which is located at a side close to the second end, with the dielectric layer interposed therebetween. A part of the anode foil on which a cathode part including the solid electrolyte layer is formed, which is located at a side close to the second end, may be referred to as a cathode formation part. For example, the anode foil includes a porous part at least in a surface layer of the cathode formation part. A part of the anode foil on which the cathode part is not formed, which is located at a side close to the first end, may be referred to as an anode lead-out part. The anode lead-out part is used for electrically connecting an anode-side external electrode, for example. An anode lead terminal may be connected to the anode lead-out part.

In the description herein, a direction extended from the first end toward the second end with the anode foil laid flat is sometimes referred to as a length direction of the anode foil. The direction from the first end toward the second end is a direction parallel with a linear direction connecting the center of an end face of the first end and the center of an end face of the second end. This direction is sometimes referred to as a length direction of the anode foil or the capacitor element.

### Dielectric Layer

The dielectric layer is formed in a manner covering at least a part of the anode foil. The dielectric layer is an insulating layer serving as a dielectric. The dielectric layer is formed by anodizing a valve metal that is on the surface of the anode foil, through an anodizing treatment, for example. With the dielectric layer formed on the surface of the anode foil having the porous part, the surface of the dielectric layer has extremely small dents and bumps corresponding to the shape of the surface of the porous part.

In the present disclosure, the average thickness T (nm) of the dielectric layer is more than or equal to 2.50×Rv, where Rv (V) represents a rated voltage of the solid electrolytic capacitor. When the dielectric layer has such an average thickness, it is possible to achieve a solid electrolytic capacitor with an excellent withstand voltage, and to suppress a breakdown upon being applied with a high voltage. Furthermore, in the present disclosure, a highly conductive solid electrolyte layer is achieved, with oxidation degradation suppressed. Therefore, even when the average thickness T of the dielectric layer is within the range described above, a relatively high initial capacitance can be achieved, and the high capacitance can be maintained even when the solid electrolyte capacitor is charged and discharged repeatedly. From the viewpoint of ensuring a higher capacitance, the average thickness T may be less than or equal to 3.50×Rv, less than or equal to 3.00×Rv, or less than or equal to 2.75×Rv.

The thickness of the dielectric layer is obtained by following the steps below. The thickness of the dielectric layer is obtained by capturing images of a measurement sample correspondingly to three fields of view, using an electron microscope (FE-SEM, Hitachi Regulus 8230), in conditions of an acceleration voltage of 2.0 kV and a magnification of 100 k times, by measuring the thicknesses of the dielectric material at 10 points per field of view, and by taking the average. The images of the cross section of the measurement sample are captured for three fields of view of (i) a boundary between the second part and the porous part, and the vicinity thereof, (ii) the vicinity of the center of the thickness of the porous part, and (iii) a part of the porous part on the side of the core part of the anode foil.

The measurement sample is prepared by following the steps below. A capacitor element or a solid electrolytic capacitor is cut into a half in the length direction of the capacitor element using a wire saw, to expose a cross section. The exposed cross section is machined using CP (Cross Section Polisher, SM-09010, manufactured by JEOL) in conditions of an output of 6.0 kV and of a processing time of 10 h. In this manner, the measurement sample described above is obtained.

The dielectric layer may be formed of a material that functions as a dielectric layer. An example of such a material of the dielectric layer includes an oxide of a valve metal. When tantalum is used as the valve metal, an example of the dielectric layer includes Ta₂O₅, and when aluminum is used as the valve metal, an example of the dielectric layer includes Al₂O₃. However, the dielectric layer is not limited to these specific examples.

When the dielectric layer is formed by an anodizing treatment, the anodizing treatment is performed by, for example, immersing the anode foil in an anodizing solution and applying a voltage. The average thickness T of the dielectric layer can be adjusted by adjusting the concentration of the anodizing solution, the composition of the anodizing solution, the voltage applied in the anodizing treatment, and the temperature and the time of the anodizing treatment, for example.

An example of the anodizing solution includes an aqueous solution containing salt. Examples of salt include phosphate, adipate, and borate. Examples of cation included in salt include an ammonium cation and an alkali metal cation. Examples of phosphate include ammonium phosphate, potassium phosphate, and sodium phosphate. Examples of ammonium phosphate include diammonium monohydrogen phosphate and monoammonium dihydrogen phosphate. The anodizing solution may contain one kind of salt, or a combination of two or more kinds of salt. An aqueous solution of ammonium phosphate, such as an aqueous solution of monoammonium dihydrogen phosphate, or an aqueous solution of ammonium adipate is preferable from a viewpoint of easiness of handling.

The concentration of the salt in the anodizing solution may be in a range from 0.2% by mass to 0.4% by mass, inclusive, or may be in a range from 0.25% by mass to 0.35% by mass, inclusive. When the salt concentration is within such a range, it is possible to achieve a relatively large average thickness T, to suppress excessive precipitation of salt, and to suppress product defects.

The voltage applied to the anode foil at the time of anodizing treatment may be in a range from 2.00 times to 2.40 times the rated voltage Rv, inclusive, a range from 2.05 times the rated voltage Rv to 2.40 V, inclusive, or a range from 2.05 times to 2.30 times the rated voltage Rv, inclusive. When the voltage is within such a range, it is possible to achieve a relatively large average thickness T, and to achieve a good balance between a high capacitance and a high withstand voltage.

The temperature of the anodizing solution used in the anodizing treatment may be in a range from 60° C. to 80° C., inclusive, or a range from 65° C. to 75° C., inclusive. When the temperature is within such a range, it is possible to achieve a relatively large average thickness T, to suppress precipitation of excessive salt, and to suppress product defects.

The time of the anodizing treatment may be in a range from 15 minutes to 90minutes, inclusive, from 25 minutes to 60 minutes, inclusive, or from 30 minutes to 60 minutes, inclusive. When the time of the anodizing treatment is within such a range, it is possible to achieve a relatively large average thickness T, while ensuring high productivity.

### Cathode Part

The cathode part at least includes a solid electrolyte layer covering at least a part of the dielectric layer. The solid electrolyte layer is formed on a part of the anode foil at a side close to the second end, with the dielectric layer interposed therebetween. The cathode part usually includes a solid electrolyte layer covering at least a part of the dielectric layer, and a cathode lead-out layer covering at least a part of the solid electrolyte layer. The solid electrolyte layer and the cathode lead-out layer will now be described.

### Solid Electrolyte Layer

The solid electrolyte layer contains a first polymer component containing a conjugated polymer, and a second polymer component containing a polymer anion. The solid electrolyte layer includes a first part filling in the voids of the porous part of the anode foil provided with the dielectric layer, and a second part disposed outside from a principal surface of the anode foil provided with the dielectric layer.

The solid electrolyte layer is formed of a solid electrolyte (that is, conductive polymer). The conductive polymer contains a conjugated polymer and a dopant. The solid electrolyte may further contain an additive as necessary.

The solid electrolyte layer may contain S element. The S element contained in the solid electrolyte is mainly derived from the conductive polymer. More specifically, the S element is included at least in the dopant, and may be included in both of the dopant and the conjugated polymer. The S element is included in at least the first part, and is usually included in both of the first part and the second part.

When the anode foil contains Al element, the abundance ratio of S element in the porous part may be more than or equal to 0.5%, more than or equal to 0.65%, or more than or equal to 0.7%, in setting the abundance ratio of Al element to be 100%. When the abundance ratio of the S element is within such a range, highly conductive solid electrolyte is densely filled in the porous part, so that deterioration of the solid electrolyte resulting from being charged and discharged repeatedly is suppressed. Furthermore, the contact points between the first part or the porous part and the second part can be maintained, so that a decrease in capacitance can be suppressed. Furthermore, it becomes possible to keep the resistance of the first part low from the initial stage, as well as the initial ESR, and to ensure a relatively high initial capacitance. Taking the volume of voids in the porous part into consideration, the abundance ratio of the S element is lower than or equal to 5%, for example. The abundance ratio of each element is obtained by carrying out element mapping of the cross section of the porous part, using EPMA.

The analysis using EPMA is performed using a sample acquired by exposing a cross section of the porous part of the capacitor element, across a part including the solid electrolyte, and forming a platinum film on the cross section. The element mapping is carried out, on the basis of the difference in wavelength of the characteristic X-rays obtained by EPMA, from a region of the cross-sectional image of the porous part including the solid electrolyte, the region including a range from the principal surface of the anode foil to the bottom of the porous part, by a width of 5 μm (that is, a region corresponding the entire thickness of the porous part on one side surface of the anode foil×a width of 5 μm), and measurements of the net intensities of the contained elements are obtained. A net intensity is obtained by removing a background (noise) from the measurement of each element. A ratio (%) of the net intensity of the S element is then obtained with respect to the net intensity of Al element as 100%. The ratio (%) of the net intensity of the S element is determined for each of a plurality of regions (e.g., five regions). An average value is then calculated, and the abundance ratio (%) of the S element is determined with respect to the abundance ratio of Al element in the porous part as 100%.

Conditions of the EPMA analysis are as follows.
Environment at the time of measurement: 25° C., atmospheric pressure
Acceleration voltage: 15.0 kV
Beam current: 20.1 nA
Integration time: 180.0 ms/point (12-minute mode)
Spectroscopic crystals: AP/CH1, PbST/CH2, PET/CH3, LiF/CH4, LSA80/CH5

The sample used for the analysis can be produced by following the steps below, for example. First, the solid electrolytic capacitor is embedded in a curable resin, and the curable resin is cured. The resultant cured product is subjected to wet polishing or dry polishing so that a cross section perpendicular to the length direction of the capacitor element and in parallel with the thickness direction of the capacitor element is exposed at a predetermined position in the length direction of the capacitor element. The exposed cross section is smoothed by ion milling. Platinum (Pt) is sputtered on the smoothed cross section using a sputtering apparatus, to form a platinum film having a thickness of 1 nm to 2 nm. In this manner, the sample for the analysis is obtained. Defining the length of the region having the solid electrolyte in the direction parallel with the length direction of the capacitor element as 1, the cross section is taken at a position in a range from 0 to 0.05, from one end of the region having the solid electrolyte, the one end being an end on the side of the second end.

### First Part

The solid electrolyte of the first part is formed by electrolytic polymerization (particularly, three-pole electrolytic polymerization). The first part may contain a first polymer component corresponding to a conjugated polymer and a second polymer component corresponding to a polymer anion containing S element.

Examples of the conjugated polymer corresponding to the first polymer component include known conjugated polymers used in solid electrolytic capacitors, such as x-conjugated polymers. An example of the conjugated polymer includes a polymer having polypyrrole, polythiophene, polyaniline, polyfuran, polyacetylene, polyphenylene, polyphenylene vinylene, polyacene, or polythiophene vinylene as a basic skeleton. The polymer may include at least one kind of monomer units forming the basic skeleton. The monomer units also include a monomer unit having a substituent. Examples of the polymer include a homopolymer and a copolymer of two or more kinds of monomers. An example of polythiophene includes PEDOT.

From the viewpoint of promoting the electrolytic polymerization in the presence of the polymer anion, the conjugated polymer may include a monomer unit corresponding to a thiophene compound, a monomer unit corresponding to a pyrrole compound, or a monomer unit corresponding to an aniline compound. The conjugated polymer may include a monomer unit corresponding to a thiophene compound. In general, a thiophene compound has a higher polymerization potential than a pyrrole compound, and does not polymerize easily. In the present disclosure, because the solid electrolyte layer is formed by three-pole electrolytic polymerization, even when a thiophene compound is used as a precursor, it is possible to speed up the progress of the polymerization reaction. Therefore, despite the use of the polymer anion, the conductive polymer component containing the first polymer component and the second polymer component containing the polymer anion can be filled highly densely in the extremely small voids on the surface of the dielectric layer, while allowing each of these polymer components to be dispersed more uniformly.

The first polymer component may include S element. The conjugated polymer included in the first polymer component includes, for example, a monomer unit corresponding to a thiophene compound. If a thiophene compound is used as a precursor, it becomes possible to promote the electrolytic polymerization even in the presence of the polymer anion including S element, by adjusting the conditions of the electrolytic polymerization. This feature is more advantageous in improving the abundance ratio of the S element in the first part. Examples of the thiophene compound include a compound having a thiophene ring and capable of forming a repeated structure of a corresponding monomer unit. Such a thiophene compound can form the repeated structure of monomer units by becoming linked at the 2-position and the 5-position of the thiophene ring.

The thiophene compound may have a substituent at at least one of the 3-position or the 4-position of the thiophene ring, for example. The substituent at the 3-position and the substituent at the 4-position may become linked to form a ring fused to a thiophene ring. Examples of the thiophene compound include thiophene which may have a substituent at at least one of the 3- or 4-positions and an alkylene dioxythiophene compound (e.g., C₂₋₄ alkylenedioxythiophene compound such as ethylenedioxythiophene compound). The alkylene dioxythiophene compound also includes those having a substituent in an alkylene group moiety.

The substituent is preferably, but is not limited to, an alkyl group (e.g., a C₁₋₄ alkyl group such as a methyl group and an ethyl group), an alkoxy group (e.g., a C₁₋₄ alkoxy group such as a methoxy group and an ethoxy group), a hydroxy group, or a hydroxyalkyl group (e.g., a hydroxy C₁₋₄ alkyl group such as a hydroxymethyl group), for example. When the thiophene compound has two or more substituents, each of the substituents may be the same, or different from the other.

A conjugated polymer (such as PEDOT) at least including a monomer unit corresponding to a 3,4-ethylenedioxythiophene compound (such as 3,4-ethylenedioxythiophene (EDOT)) may be used. The conjugated polymer at least including a monomer unit corresponding to EDOT may include only the monomer unit corresponding to EDOT, or may include a monomer unit corresponding to another thiophene compound, in addition to the monomer unit corresponding to EDOT.

The weight-average molecular weight (Mw) of the conjugated polymer is not limited to any particular value, and is, for example, in a range from 1,000 to 1,000,000, inclusive.

Note that the weight-average molecular weight (Mw) herein is a value in terms of polystyrene measured by gel permeation chromatography (GPC). Usually, GPC is measured using a polystyrene gel column, and water and methanol (volume ratio 8:2) as a mobile phase.

The first part may contain the second polymer component corresponding to the polymer anion including S element, as the dopant. Examples of the polymer anion included in the second polymer component include polymers having a plurality of sulfo groups. By using the second polymer component, the abundance ratio of the S element in the first part can be increased easily. Furthermore, it is possible to achieve a highly conductive solid electrolyte layer, and to better suppress dedoping from the solid electrolyte layer. The polymer anion may also include another anionic group (e.g., a carboxy group), in addition to the sulfo group.

In the solid electrolyte, the anionic group (such as a sulfo group and a carboxy group) of the dopant may be included in the free form, in the form of anions, or in the form of salt, or may be included in the form bonded to or interacting with the conjugated polymer. In the description herein, an anionic group in any of these forms will be sometimes simply referred to as an “anionic group”, a “sulfo group”, a “carboxy group”, or the like.

The polymer anion may include a monomer unit M₁ corresponding to an organic sulfonic acid compound. The organic sulfonic acid compound may be any one of aliphatic, alicyclic, aromatic, and heterocyclic. The polymer anion may be a homopolymer only including the monomer units M₁, or may be a copolymer including other monomer units as well as the monomer units M₁.

One example of the polymer anion having a sulfo group is a polymeric sulfonic acid. Specific examples of the polymer anion include polyvinylsulfonic acid, polystyrenesulfonic acid (including a copolymer and a substituted compound having a substituent), polyallylsulfonic acid, polyacrylsulfonic acid, polymethacrylsulfonic acid, poly (2-acrylamide-2-methylpropanesulfonic acid), polyisoprenesulfonic acid, polyestersulfonic acid (e.g., aromatic polyester sulfonic acid), and phenolsulfonic acid novolac resin. However, the polymer anion is not limited to these specific examples. The solid electrolyte may contain one kind of polymer anion or two or more kinds of polymer anion in combination.

In particular, when the polymer anion has an aromatic ring, high heat resistance is obtained, so that dedoping is suppressed even when the solid electrolytic capacitor is exposed to a high temperature, and the high conductivity of the solid electrolyte layer can be maintained. In the capacitor element according to the present disclosure, even when a polymer anion having an aromatic ring is used, it is possible to suppress segregation of the polymer anion in the surface layer and the first part of the solid electrolyte layer, and to achieve a solid electrolyte layer in which each of the first polymer component and the second polymer component is dispersed more uniformly. Such excellent dispersions can be confirmed in a Raman spectrum.

An example of the polymer anion having an aromatic ring is a polymer anion having an aromatic ring, among the polymer anions including a monomer unit M₁ corresponding to an organic sulfonic acid compound. As such a polymer anion, a polymer anion including at least a monomer unit (sometimes referred to as a monomer unit M₂) corresponding to an aromatic sulfonic acid compound as the monomer unit M₁ is preferable. Examples of such a polymer anion include, but are not limited to, polystyrene sulfonic acid (including a copolymer and a substituted compound having a substituent), aromatic polyestersulfonic acid, and a phenol sulfonic acid novolac resin, among the polymer anions listed above.

The Mw of the polymer anion is, for example, in a range from 100 to 500,000, inclusive. From the viewpoint of allowing the voids of the porous part to be filled with the conductive polymer highly densely, the Mw of the polymer anion contained in the first part is preferably less than or equal to 100,000, more preferably in a range from 1000 to 100,000, inclusive, or in a range from 10,000 to 100,000, inclusive. With Mw of the polymer anion within such a range, there are tendencies that the polymer anion becomes better dispersed, and the doping concentration becomes relatively high, in the first part. This setting is therefore advantageous in ensuring a higher conductivity. In addition, there is a tendency that the dopant and the conductive polymer become highly stabilized.

The amount of the dopant contained in the first part is, for example, in a range from 10 parts by mass to 1000 parts by mass, inclusive, and may be from be 20 parts by mass to 500 parts by mass, inclusive, with respect to 100 parts by mass of the conjugated polymer. The amount may be in a range from 50 parts by mass to 200 parts by mass, inclusive, from the viewpoint of improving the dispersibility of the polymer anion and achieving a relatively high doping concentration.

### Method of Forming Solid Electrolyte Layer

The first part may be formed by carrying out three-pole electrolytic polymerization of a precursor of the conjugated polymer, in the presence of the dopant, on the surface of the dielectric layer. For example, the electrolytic polymerization is carried out by immersing the cathode formation part of the anode foil, with the dielectric layer having been formed on a surface, in a liquid composition (polymerization liquid) containing the precursor of the conjugated polymer and the dopant. By adjusting the conditions of the electrolytic polymerization, it is possible to fill the fine voids of the porous part with the solid electrolyte highly densely, and to increase the abundance ratio of S element. It is also possible to dope the dopant at a relatively high doping concentration, to achieve a high conductive first part, and to stabilize the conjugated polymer in terms of energy. Therefore, it is not only possible to suppress deterioration of the solid electrolyte in the first part, but also to suppress peeling of the second part even when the solid electrolyte capacitor is charged and discharged repeatedly. Hence, a high conductivity can be ensured across the entire solid electrolyte layer, and a high capacitance can be ensured.

Examples of the precursor of the conjugated polymer include a raw material monomer of the conjugated polymer, and an oligomer and a prepolymer in which a plurality of molecular chains of the raw material monomer are linked. One type of precursor may be used, or two or more types of precursor may be used in combination. From the viewpoint for achieving a conjugated polymer with better orientation, at least one selected from the group consisting of a monomer and an oligomer (in particular, monomer) is preferably used as the precursor.

The liquid composition typically contains a solvent. Examples of the solvent include water, an organic solvent, and a mixed solvent of water and an organic solvent (such as a water-soluble organic solvent).

When another conductive material, an additive, and the like are used, they may be added to the liquid composition.

The liquid composition may contain an oxidizing agent as necessary. The oxidizing agent may be applied to the anode foil before or after the liquid composition is brought into contact with the anode foil having the dielectric layer formed thereon. Examples of such an oxidizing agent include a compound capable of generating Fe³⁺ (such as a ferric sulfate), a persulfate (such as a sodium persulfate or an ammonium persulfate), and a hydrogen peroxide. One type of oxidizing agent may be used alone, or two or more types of oxidizing agent may be used in combination.

The three-pole electrolytic polymerization is carried out while the anode foil, the counter electrode, and the reference electrode are immersed in the liquid composition. As the counter electrode, for example, a Ti electrode is used, but the counter electrode is not limited thereto. As the reference electrode, a silver/silver chloride electrode (Ag/Ag⁺) is preferably used.

The voltage (polymerization voltage) applied to the anode foil during the electrolytic polymerization is, for example, in a range from 0.6 V to 1.5 V, inclusive. The polymerization voltage is preferably in a range from 0.9 V to 1.2 V (or to 1.1 V), inclusive, and may be in a range from 1 V to 1.2 V (or to 1.1 V), inclusive, from the viewpoint of allowing the voids of the porous part to be filled highly densely, and better achieving relatively high crystallinity of the solid electrolyte. By carrying out the three-pole electrolytic polymerization at such a polymerization voltage, the polymerization reaction in the voids can be controlled precisely. Thus, a polymer chain of the conjugated polymer can be grown inside the voids with the dopant highly dispersed, and the voids can be filled with the solid electrolyte highly densely. In addition, since the polymerization is allowed to take place slowly, it is possible to achieve a conjugated polymer with improved orientation and crystallinity, to achieve a relatively high doping concentration, and to ensure a relatively high conductivity. Note that the polymerization voltage is a potential of the anode foil with respect to that of reference electrode (silver/silver chloride electrode (Ag/Ag⁺)). During the electrolytic polymerization, a power feeder (such as a power feeding tape) is electrically connected to the anode lead-out part, and a voltage is applied to the anode foil via the power feeder. The potential of the anode foil corresponds to the potential of the power feeder electrically connected to the anode foil.

The electrolytic polymerization may be carried out at a temperature in a range from 5° C. to 60° C., inclusive, or in a range from 15° C. to 35° C., inclusive, for example.

A precoat layer may be formed on the surface of the dielectric layer, prior to the electrolytic polymerization. The precoat layer contains, for example, a conductive material. The precoat layer may be formed using a liquid dispersion containing a conductive polymer (such as a conjugated polymer and a dopant). The liquid dispersion used in forming the precoat layer contains the conductive polymer having a smaller particle size at a lower concentration, compared with the liquid dispersion used in forming the solid electrolyte by which the cathode part is formed. For example, the average primary particle size of the particles of the conductive polymer contained in the liquid dispersion for the precoat layer is, for example, smaller than or equal to 100 nm, and may be smaller than or equal to 60 nm. The concentration of the dry solid content of the liquid dispersion is, for example, less than or equal to 1.2 mass %. The conductive polymer in the liquid dispersion used in forming the solid electrolyte by which the cathode part is formed usually has particles with an average primary particle size larger than or equal to 200 nm, and a dry solid content concentration greater than or equal to 2 mass %. The conjugated polymer of the precoat layer and the conjugated polymer formed by the electrolytic polymerization may be of the same type or different types. The dopant of the precoat layer and the dopant used in the electrolytic polymerization may be the same or different. In the present disclosure, because the first part is formed by electrolytic polymerization, a polymerization liquid is allowed to permeate into the fine voids sufficiently, so that it is possible to achieve a first part with a high packing density, even when a precoat layer is formed using a liquid dispersion.

### Second Part

The second part may have at least one of the composition and the film property different from those of the first part, or be the same in both of the composition and the film property. In a configuration in which the entire solid electrolyte includes a plurality of layers, the first part may be a first layer and the second part may be a second layer. In this case, the first layer and the second layer may be different in at least one of the composition and the film property, or be the same in both of the composition and the film property. In addition, the second part may include a plurality of layers. At least two of such plurality of layers may be different in at least one of the composition and the film property, or may be the same in both.

The solid electrolyte of the second part is formed by electrolytic polymerization (particularly, three-pole electrolytic polymerization), accordingly to the way in which the first part is formed. As a result, in the Raman spectrum of the surface layer of the solid electrolyte layer, a peak that is characteristic to the first polymer component is observed, and a highly oriented conjugated polymer with high crystallinity can be achieved. The dopant is highly dispersed across the entire solid electrolyte of the second part, and there are tendencies that a high conductivity is achieved, and deterioration of the solid electrolyte is suppressed.

The conjugated polymer contained in the second part may be selected, for example, from the conjugated polymers described for the first part. The Mw of the conjugated polymer may be selected from the range described for the first part. As the dopant, at least one type selected from the group consisting of the polymer anions described for the first part and an anion may be used. Examples of the anions include a sulfate ion, a nitrate ion, a phosphate ion, a borate ion, an organic sulfonate ion, and a carboxylate ion, without limitation to these particular examples. Examples of the dopant that generates sulfonate ions include p-toluenesulfonic acid and naphthalenesulfonic acid. From the viewpoint of better achieving stability, it is preferable to use a polymer anion.

The Mw of the polymer anion may also be selected from the ranges described for the first part.

The Mw of the polymer anion can be obtained from a sample collected from a capacitor element or a solid electrolytic capacitor. More specifically, a GPC measurement may be carried out using a sample collected by following the steps described below. First, a cured product obtained following the same steps as that for the sample for the Raman spectrum measurement, to be described later, is subjected to polishing treatment or cross-section polishing processing to expose the solid electrolyte layer. The solid electrolyte layer is then scraped off from the solid electrolyte layer, to extract the polymer anion using hot water at a temperature in a range from 80° C. to 100° C., inclusive. The extract is then concentrated to obtain the sample for measurement.

A content of the dopant in the solid electrolyte may be, for example, in a range from 10 parts by mass to 1000 parts by mass, inclusive, from 20 parts by mass to 500 parts by mass, inclusive, or from 50 parts by mass to 200 parts by mass, inclusive, with respect to 100 parts by mass of the conjugated polymer.

The polymerization voltage used in the electrolytic polymerization for forming the second part may be in the range described for the first part, and may be in a range from 0.6 V to 1.5 V, inclusive, or may be in a range from 0.7 V to 1.2 V, inclusive.

### Raman Spectrum

In the solid electrolytic capacitor according to the present disclosure, the first peak that is characteristic to the first polymer component (conjugated polymer) is observed in a Raman spectrum of the surface layer of the solid electrolyte layer. The main component of the solid electrolyte layer is the conjugated polymer. The peak (first peak) attributed to the C═C stretching vibration derived from the conjugated polymer exhibits the highest peak in the Raman spectrum of the surface layer of the solid electrolyte layer, and this height is characterizing. The solid electrolyte in the surface layer has high crystallinity due to the highly orientated conjugated polymer. Furthermore, the conjugated polymer in the solid electrolyte layer is energetically stable. For these reasons, the surface layer exhibits a characterizing Raman spectrum, in which the first peak described above is observed. Furthermore, the second peak that is characteristic to the second polymer component is also observed, in the Raman spectrum of the surface layer of the solid electrolyte layer.

For example, when the conjugated polymer contains a monomer unit corresponding to a thiophene compound, the first peak is observed in a wavenumber range from 1200 cm⁻¹ to 1600 cm⁻¹, inclusive, in the Raman spectrum of the surface layer of the solid electrolyte layer. The first peak is attributed to the C═C stretching vibration of the thiophene ring in the monomer unit corresponding to the thiophene compound. When the polymer anion contains a monomer unit corresponding to the aromatic sulfonic acid compound, the second peak is observed in a wavenumber range from 800 cm⁻¹ to 1100 cm⁻¹, inclusive, in the Raman spectrum of the surface layer. This second peak is attributed to the C—S stretching vibration between the aromatic ring and the S element of the sulfo group in the monomer unit corresponding to the aromatic sulfonic acid compound. For example, when the conjugated polymer includes at least a monomer unit corresponding to EDOT, the wavenumber at the position of the first peak is in a range from 1400 cm⁻¹ to 1450 cm⁻¹, inclusive, and may be in a range from 1410 cm⁻¹ to 1435 cm⁻¹, inclusive. When the polymer anion includes at least polystyrene sulfonic acid, the wavenumber at the position of the second peak is in a range from 900 cm⁻¹ to 1050 cm⁻¹, inclusive, and may be in a range from 950 cm⁻¹ to 1050 cm⁻¹, inclusive, for example.

In the Raman spectrum of the surface layer of the solid electrolyte layer formed using the liquid dispersion, by contrast, the characterizing peaks described above are not observed. This is possibly because fluorescence emission inhibits the observation of Raman scattered light. In the preparation of the liquid dispersion, polymerization takes place in the liquid phase. Therefore, in the particles of the conductive polymer thus obtained, polymer anions having a high molecular weight segregate more to the surface, than that in the precursor of the conjugated polymer. It is considered that, when the liquid dispersion is used, the particles of the conductive polymer with the polymer anions segregated on the surface are applied on the surface of the anode foil, including the porous part; and therefore, the characterizing peaks are not observed in the Raman spectrum of the surface layer of the solid electrolyte layer, due to the fluorescence emission from the segregated polymer anions.

With the capacitor element according to the present disclosure, in the Raman spectrum of the surface layer of the solid electrolyte layer, a ratio Iₚ₁/Iₚ₂ of the intensity Iₚ₁ of the first peak that is characteristic to the first polymer component (conjugated polymer) with respect to the intensity Iₚ₂ of the second peak that is characteristic to the second polymer component (polymer anion) may be more than or equal to 2, more than or equal to 3, or more than or equal to 4. When the ratio Iₚ₁/Iₚ₂ is within these ranges, the conjugated polymer in the surface layer of the solid electrolyte layer has relatively high orientation and crystallinity. In such a case, it can be said that the conjugated polymer in the second part also has relatively high orientation and crystallinity. Therefore, a higher conductivity can be ensured in the solid electrolyte of the second part. From the viewpoint of better ensuring higher crystallinity and conductivity of the second part, the ratio Iₚ₁/Iₚ₂ may be more than or equal to 5 or more than or equal to 5.5. The ratio Iₚ₁/Iₚ₂ is, for example, less than or equal to 10. The ratio Iₚ₁/Iₚ₂is preferably lower than or equal to 7, from the viewpoint of achieving a relatively high doping concentration to better ensure higher conductivity. For example, the ratio Iₚ₁/Iₚ₂ is in a range from 2 to 10 (or to 7), inclusive, and may be in a range from 4 to 10 (or 7), inclusive. In these numerical ranges, the lower bound values may be replaced with the values mentioned above. A peak intensity herein corresponds to a peak height resultant of subtracting the height of the background from the height of each peak.

In the present disclosure, even in the solid electrolyte formed inside the voids of the porous part, it is possible to achieve a highly oriented and crystalline conjugated polymer, and to achieve a high conductivity. Therefore, a Raman spectrum similar to the Raman spectrum of the surface layer of the solid electrolyte layer is also observed in the first part. The ratio Iₚ₁/Iₚ₂ of the intensity Iₚ₁ of the first peak to the intensity Iₚ₂ of the second peak in the Raman spectrum of the first part can be selected from the ranges of Iₚ₁/Iₚ₂ in the Raman spectrum of the surface layer.

In the Raman spectrum of the surface layer of the solid electrolyte layer, sometimes the peak that is characteristic to the first polymer component is also observed in a wavenumber range from 2750 cm⁻¹ to 3000 cm⁻¹, inclusive (sometimes referred to as a third peak). The third peak has a peak height lower than the first peak; however, since the third peak is not inhibited by the fluorescence emission of the segregated polymer anion, the third peak is clearly observable. The wavenumber range where the third peak is observed may be in a range from 2800 cm⁻¹ to 3000 cm⁻¹, inclusive, or from 2800 cm⁻¹ to 2900 cm⁻¹, inclusive. For example, when PEDOT is used as the first polymer component, the third peak is observed in a wavenumber range from 2800 cm⁻¹ to 2900 cm⁻¹, inclusive.

In the description herein, the Raman spectrum of the surface layer and the first part of the solid electrolyte layer is measured on a cross section of the solid electrolyte layer at a predetermined position of the solid electrolytic capacitor or the solid electrolytic capacitor element, under the following conditions. The surface layer of the solid electrolyte layer herein refers to a part from the surface of the solid electrolyte layer to the depth of 100 nm. Measurements of the Raman spectrum of the first part are collected from the solid electrolyte inside the voids of the porous part.

Raman spectrometer: RamanFORCE PAV manufactured by NanoPhoton Corporation
Diffraction grating: 600 gr/cm
Measurement wavenumber range: from 0 cm⁻¹ to 2500 cm⁻¹, inclusive
Temperature: 25° C.

The wavelength of the laser light emission, the laser power density, and the exposure time are determined depending on the type of the conjugated polymer. For example, when the conjugated polymer is PEDOT, the laser light emission wavelength is set to 784.73 nm, the laser power density is set to 870 W/cm², and the exposure time is set to 60 seconds.

For the measurements of a Raman spectrum, a sample collected by the following steps may be used. First, the solid electrolytic capacitor is embedded in a curable resin, and the curable resin is cured. Polishing treatment or cross-section polishing processing is applied to the cured product to expose a cross section of the cured product, the cross section being parallel with the thickness direction and perpendicular to the length direction of the capacitor element. Defining the length of the region with the solid electrolyte in the direction parallel with the length direction of the capacitor element as 1, the cross section is taken at a position in a range from 0 to 0.05, from an end of the region with the solid electrolyte, the end being an end on the opposite side of the anode lead-out part (the end on the side of the second end). In the manner described above, the sample for the measurement is obtained. The Raman spectrum is then measured, on the exposed cross section of the sample, from an area of 8 μm×8 μm of the solid electrolyte (first part) inside the void on the surface of the porous part. The intensities of the first peak and the second peak are then calculated by averaging the values measured at 12 points in the area of 8 μm×8 μm of the first part inside the void of the porous part.

### Others

Each of the first part and the second part may further contain at least one selected from the group consisting of a known additive and a known conductive material other than the conductive polymer, as necessary. Examples of the conductive material include at least one kind selected from the group consisting of conductive inorganic materials such as manganese dioxide and TCNQ complex salts.

Examples of the additive include a known additive (such as a coupling agent and a silane compound) added to the solid electrolyte, a known conductive material other than the conductive polymer, and a water-soluble polymer. Each of the first part and the second part (or each layer forming each of these parts) may contain one of these additives, or may contain two or more of these additives in combination. In a case where each of these parts includes a plurality of layers, each of such layers may contain the same additives or different additives.

Each of the first part and the second part may be a single layer or may include a plurality of layers. When each of these parts includes a plurality of layers, the type, the composition, the content, and the like of the conductive polymer component, the additive, and the like contained in each of such layers may be different or the same, among the layers. A layer for improving adhesiveness may be disposed between the dielectric layer and the solid electrolyte.

### Cathode Lead-Out Layer

The cathode lead-out layer only needs to include at least a first layer that is in contact with the solid electrolyte layer and that covers at least a part of the solid electrolyte layer, and may include a first layer and a second layer that covers at least a part of the first layer.

Examples of the first layer include a layer containing conductive particles, and a metal foil. Examples of the conductive particles include at least one kind selected from conductive carbon and metal powder. For example, the cathode lead-out layer may include a layer containing conductive carbon (a carbon layer) as the first layer, and a layer containing metal powder or a metal foil as the second layer. When a metal foil is used as the first layer, the metal foil may form the cathode lead-out layer.

Examples of the conductive carbon include graphite (e.g., artificial graphite or natural graphite).

The layer containing metal powder, which is the second layer, may be formed by laying a composition containing metal powder as a layer, on a surface of the first layer, for example. Examples of such a second layer include a metal-particle-containing layer formed using a paste containing metal powder and a resin binder. A thermoplastic resin may be used as the resin binder, but it is preferable to use a thermosetting resin such as an imide resin or an epoxy resin. As the metal powder, silver-containing particles may be used, from the viewpoint of achieving higher conductivity of the second layer. Examples of the silver-containing particles include silver particles and silver-alloy particles. The second layer may contain one kind of silver-containing particles, or may contain two or more kinds of silver-containing particles in combination. The silver particles may contain a small amount of impurities.

When a metal foil is used as the first layer, the metal is not limited to a particular kind of metal. It is preferable to use a valve metal such as aluminum, tantalum, or niobium, or an alloy containing the valve metal, for the metal foil. The metal foil may have a roughened surface, as necessary. The surface of the metal foil may be provided with an anodization film, or may be provided with a film of metal different from the metal forming the metal foil (dissimilar metal), or a nonmetal film. Examples of the dissimilar metal and the nonmetal include metals such as titanium, and nonmetals such as carbon (e.g., conductive carbon).

A film of the dissimilar metal or the nonmetal (e.g., conductive carbon) described above may form the first layer, and the metal foil described above may form the second layer.

When a metal-particle-containing layer is included in the cathode lead-out layer, the entire cathode lead-out layer may be provided as the metal-particle-containing layer; or the first layer may be the metal-particle-containing layer, or the second layer may be the metal-particle-containing layer. For example, the cathode lead-out layer may include a first layer (carbon layer) containing conductive carbon, and a second layer including a metal-particle-containing layer that covers at least a part of the first layer.

The cathode lead-out layer is formed using a known method suitable for the layer configuration. For example, in a case where the cathode lead-out layer includes a metal foil as the first layer or the second layer, the first layer or the second layer is formed by laying a metal foil in a manner covering at least a part of the solid electrolyte layer or of the first layer. The first layer containing conductive particles is formed by, for example, applying a conductive paste or a liquid dispersion that contains conductive particles and resin binder (such as water-soluble resin or curable resin), as necessary, to the surface of the solid electrolyte layer. The second layer containing metal powder is formed by applying a paste that contains metal powder and resin binder, to the surface of the first layer, for example. In a process of forming the cathode lead-out layer, a drying treatment, a heat treatment, or the like may be applied as necessary.

### Separator

When a metal foil is used in the cathode lead-out layer, a separator may be disposed between the metal foil and the anode foil. There is no particular limitation to the separator. For example, it is possible to use a nonwoven fabric including fibers of cellulose, polyethylene terephthalate, vinylon, or polyamide (for example, aliphatic polyamide or aromatic polyamide such as aramid).

### Others

The solid electrolytic capacitor according to the present disclosure has excellent charging and discharging characteristics, while suppressing a breakdown caused by a high voltage application, and exhibits excellent withstand voltage. Therefore, the solid electrolytic capacitor according to the present disclosure is suitable for applications using high voltages, and can ensure a high safety factor at a rated voltage. For example, by setting the average thickness T (nm) of the dielectric layer to more than or equal to 2.50×Rv, the safety factor more than or equal to 2 times can be ensured for the rated voltage. Rated voltage Rv of the solid electrolytic capacitor may be more than or equal to 12 V, or more than or equal to 16 V.

The solid electrolytic capacitor includes at least one capacitor element. The solid electrolytic capacitor may be a wound capacitor, or may be either a chip capacitor or a stacked capacitor. The electrolytic capacitor may include a plurality of stacked capacitor elements, for example. The solid electrolytic capacitor may also include two or more wound capacitor elements. The configuration of the capacitor elements may be selected depending on the type of the solid electrolytic capacitor.

To the cathode lead-out layer of the capacitor element, one end of a cathode lead terminal is electrically connected. For example, a conductive adhesive is applied to the cathode lead-out layer, and the cathode lead terminal is bonded to the cathode lead-out layer with the conductive adhesive interposed therebetween. To the anode foil, one end of an anode lead terminal is electrically connected. The other ends of the anode lead terminal and the cathode lead terminal are drawn out of the resin exterior body or the case. The other end of each of these terminals exposed from the resin exterior body or the case is used to connect to a substrate on which the solid electrolytic capacitor is to be mounted, for example, by soldering.

The capacitor element is sealed by the resin exterior body or the case. For example, the capacitor element and a material resin (e.g., uncured thermosetting resin and filler) of the exterior body may be placed inside a mold, to seal the capacitor element with the resin exterior body using a transfer molding method, a compression molding method, or the like. At this time, a part of the other end of the anode lead terminal and a part of the other end of the cathode lead terminal, the other ends having been drawn out from the capacitor element are exposed from the mold, with the anode lead terminal being connected to an anode lead. The solid electrolytic capacitor may be formed by housing the capacitor element in a bottomed case in such a manner that such parts of the other ends of the anode lead terminal and of the cathode lead terminal are positioned near an opening of the bottomed case, and by sealing the opening of the bottomed case using a sealing body.

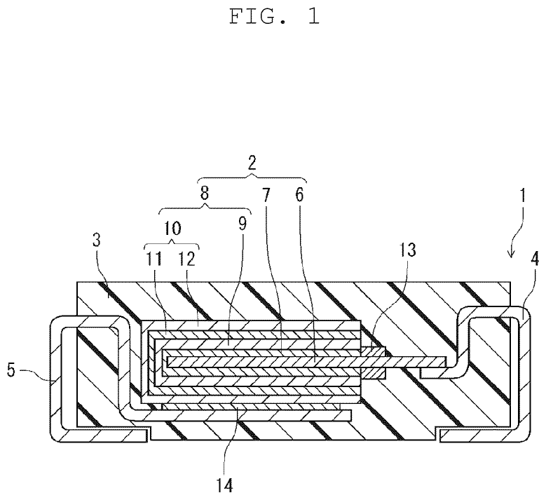

FIG. 1 is a sectional view schematically illustrating a structure of a solid electrolytic capacitor according to an exemplary embodiment of the present disclosure. As illustrated in FIG. 1, solid electrolytic capacitor 1 includes capacitor element 2, resin exterior body 3 that seals capacitor element 2, and anode lead terminal 4 and cathode lead terminal 5 each of which is at least partially exposed to an outside of resin exterior body 3. Anode lead terminal 4 and cathode lead terminal 5 can be made using a metal such as copper or a copper alloy. Resin exterior body 3 has a substantially rectangular parallelepiped outer shape, and solid electrolytic capacitor 1 also has a substantially rectangular parallelepiped outer shape.

Capacitor element 2 includes anode foil 6 made of aluminum foil, dielectric layer 7 covering anode foil 6, and cathode part 8 covering dielectric layer 7. Cathode part 8 includes solid electrolyte layer 9 covering dielectric layer 7, and cathode lead-out layer 10 covering solid electrolyte layer 9. Anode foil 6 has porous part on the surface layer on both sides, the porous part being formed by etching, for example. In a Raman spectrum of the surface layer of solid electrolyte layer 9, the peak that is characteristic to the first polymer component containing the conjugated polymer is observed. The average thickness T (nm) of the dielectric layer 7 is more than or equal to 2.50×Rv.

Anode foil 6 has an area facing cathode part 8 and another area not facing cathode part 8. Inside the area of anode foil 6 not facing cathode part 8, a part adjacent to cathode part 8 is provided with insulating separation part 13 in a manner covering the surface of anode foil 6 in a band-like shape, so as to restrict the contact between cathode part 8 and anode foil 6. Another part of the area not facing cathode part 8 is welded to anode lead terminal 4, to electrically connect anode foil 6 to the anode lead terminal 4. To cathode part 8, cathode lead terminal 5 is electrically connected via adhesive layer 14 made of a conductive adhesive.

### EXAMPLES

The present disclosure will now be described specifically with reference to examples and comparative examples, but the present disclosure is not limited to the following examples.

### Solid Electrolytic Capacitors A1 to A2 and R1

Solid electrolytic capacitor 1 illustrated in FIG. 1 (solid electrolytic capacitors A1, A2, and R1) was produced in the following manner, and its characteristics were evaluated.

### (1) Preparation of Anode Foil 6

Both surfaces of an aluminum foil (thickness: 130 μm) were roughened by etching to prepare anode foil 6. The thickness of each of the porous parts formed on the respective surface layers of the anode foil was set to 50 μm.

### (2) Formation of Dielectric Layer 7

A cathode formation part of anode foil 6 was immersed in an anodizing solution kept at 70° C., and a DC voltage indicated Table 2 was applied to form dielectric layer 7 containing aluminum oxide. As the anodizing solution, an ammonium adipate aqueous solution at a concentration of 0.3 mass % was used. The voltage applied during the anodizing was adjusted on the basis of rated voltage Rv in such a manner that average thickness T of dielectric layer 7 and rated voltage Rv of the solid electrolytic capacitor had the relationship indicated in Table 2. The time for which the voltage was applied was set between 25 minutes and 35 minutes.

### (3) Formation of Solid Electrolyte Layer 9

Separation part 13 was formed by pasting an insulating resist tape between the region where solid electrolyte layer 9 was to be formed and the region where solid electrolyte layer 9 was not to be formed, on anode foil 6 having been provided with dielectric layer 7. Anode foil 6 having been provided with separation part 13 was then immersed in a liquid composition containing a conductive material, was taken out therefrom, and then dried, to form a precoat layer (not illustrated).

A mixed solution was then prepared by dissolving EDOT monomers and PSS (Mw: 100,000), which is a polymer anion, into ion-exchanged water. While stirring the mixed solution, iron (II) sulfate (oxidizing agent) having been dissolved in ion-exchanged water was added to the mixed solution, to prepare a polymerization liquid. Using the obtained polymerization liquid, three-electrode electrolytic polymerization was carried out. More specifically, anode foil 6 provided with the precoat layer, a counter electrode, and a reference electrode (silver/silver chloride reference electrode) were immersed in the polymerization liquid. A voltage was then applied to anode foil 6 so as to bring the potential of anode foil 6 with respect to the reference electrode (polymerization voltage) to 1.0 V, and electrolytic polymerization was carried out at 25° C., to form solid electrolyte layer 9.

### (4) Formation of Cathode Lead-Out Layer 10

Anode foil 6 obtained in the process in (3) above was then immersed in a dispersion liquid containing graphite particles dispersed in water, was taken out from the dispersion liquid, and then dried, to form first layer (carbon layer) 11 at least on the surface of solid electrolyte layer 9. Drying was performed at a temperature in a range from 130° C. to 180° C., inclusive, for 10 minutes to 30 minutes.

Next, a silver paste containing silver particles and binder resin (epoxy resin) was applied onto the surface of first layer 11, and heated at 150° C. to 200° C. for 10 minutes to 60 minutes to cure the binder resin, to form second layer (metal-particle-containing layer) 12. In this manner, cathode lead-out layer 10 including first layer (carbon layer) 11 and second layer (metal-particle-containing layer) 12 was formed, and cathode part 8 including solid electrolyte layer 9 and cathode lead-out layer 10 was formed.

In the manner described above, capacitor element 2 was produced.

### (5) Assembly of Solid Electrolytic Capacitor

Cathode part 8 of capacitor element 2 obtained in (4) above was then bonded to one end of cathode lead terminal 5 with adhesive layer 14 of a conductive adhesive. One end of anode foil 6 protruding from capacitor element 2 and one end of anode lead terminal 4 were joined by laser welding.

Resin exterior body 3 made with an insulating resin was formed around capacitor element 2 by molding. At this time, the other end of anode lead terminal 4 and the other end of cathode lead terminal 5 were kept drawn out of resin exterior body 3.

In this manner, solid electrolytic capacitors 1 (A1, A2, and B1) with rated voltage Rv of 20 V were obtained. In the same manner as described above, twenty solid electrolytic capacitors in total were produced.

### Solid Electrolytic Capacitor B1

Solid electrolyte layer 9 was formed by following the steps described below. A solid electrolytic capacitor was produced in the same manner as solid electrolytic capacitor A1, except for the steps described below.

Anode foil 6 having been provided with dielectric layer 7 was immersed in a liquid dispersion containing a conductive polymer, and dried at 120° C. for 10 to 30 minutes. By repeating the process of immersing anode foil in the liquid dispersion and drying four times, solid electrolyte layer 9 was formed. As the liquid dispersion, an aqueous dispersion containing PEDOT and PSS (Mw=160,000) at a concentration of 2 mass % to 4 mass % (with the average particle size of the conductive polymer in the dispersion: 400 nm to 600 nm) was used.

### Evaluations

Using the solid electrolytic capacitors, the following evaluations were carried out.

### (a) Measurement of Raman Spectrum of Solid Electrolyte Layer

Using each of the solid electrolytic capacitors, the Raman spectrum of a cross section of the solid electrolyte layer was measured following the steps above. In the Raman spectrum of the surface layer and the first part of the solid electrolyte layer of each of the solid electrolytic capacitors A1 and A2, a peak (first peak) that is characteristic to the five-membered ring of PEDOT was observed at a wavenumber around 1420 cm⁻¹, and a peak (second peak) that is characteristic to the aromatic ring-S element bond of PSS was observed at a wavenumber around 1000 cm⁻¹. For the first part of the solid electrolyte layer, the intensity Iₚ₁ of the first peak and the intensity Iₚ₂ of the second peak were obtained, and the ratio Iₚ₁/Iₚ₂ was then calculated.

### (b) Abundance Ratio of S Element in Porous Part

Using each of the solid electrolytic capacitors, an EPMA analysis of a cross section of the porous part of anode foil 6 was carried out, by following the steps described above, and the net intensity of Al element and S element was obtained from element mapping. The abundance ratio of the S element was determined from the net intensity of these elements, by following the steps described above.

### (c) Electrostatic Capacity

The initial electrostatic capacity (μF) of each of the solid electrolytic capacitors at a frequency of 120 Hz was measured using an LCR meter for 4-terminal measurement, in an environment of 20° C. An average (C₀) over the twenty solid electrolytic capacitors was obtained.

The solid electrolytic capacitor was then charged at a rated voltage for 30 seconds, and discharged at the rated voltage for 30 seconds, at a temperature of 70° C. More specifically, with the profile indicated in Table 1 below, a first cycle of charging and discharging and a second cycle of charging and discharging were repeated in this order, until 10,000 cycles were reached. The electrostatic capacity was then measured in an environment of 20° C. by following the same steps as for the initial electrostatic capacity, and an average (C1) over the twenty solid electrolytic capacitors was obtained. The rate of change in the electrostatic capacity (AC) was obtained on the basis of the following formula.

$$Rate of Change in Electrostatic Capacity ( Δ C ) : ( {C}_{1} - {C}_{0} ) / {C}_{0} \times 100 ( \% )$$

The rate of change in the electrostatic capacity takes a negative value. When the rate of change of the electrostatic capacity is smaller, it means that the capacitance has dropped further after repeated charging and discharging.

TABLE 1

| | | Time | Voltage | Rate of voltage |
|---|---|---|---|---|
| | | (sec) | (V) | increase (V/sec) |
| First | (1) | 0 | 0 | |
| cycle | (2) | ↓ | ↓ | +0.667 |
| | (3) | 30 | 20 | |
| | (4) | ↓ | ↓ | −0.667 |
| Second | (5) | 60 | 0 | |
| cycle | (6) | ↓ | ↓ | +0.667 |
| | (7) | 90 | 20 | |
| | (8) | ↓ | ↓ | −0.667 |
| | Go back to (1) | (0) | (0) | |

### (d) Withstand Voltage

A voltage was applied to the electrolytic capacitor at 70° C., while increasing the voltage at a rate of 1.0 V/s, a breakdown voltage (V) at which an overcurrent of 0.5 A flows was then measured.

The evaluation results are indicated in Table 2. Solid electrolytic capacitors A1 and A2 are those according to the example; solid electrolytic capacitor R1 is that of a reference example; and solid electrolytic capacitor B1 is that of a comparative example. Initial capacitance C₀ and the initial ESR are relative values representing those of the solid electrolytic capacitor B1 as 100.

TABLE 2

| | | Average | | Abundance | | | | |
|---|---|---|---|---|---|---|---|---|
| | Voltage in | thickness T of | | ratio of S | | C₀ | | Average value |
| | anodizing | dielectric layer | Formation of solid | element | Ip₁/Ip₂ | Relative | ΔC | of breakdown |
| | (V) | (nm) | electrolyte layer | (%) | First part | value | (%) | voltage (V) |
| A1 | 2.10 × Rv | 2.50 × Rv | Electrolytic | 0.78 | 5.8 | 100 | −2 | 44 |
| | | | polymerization | | | | | |
| A2 | 2.25 × Rv | 2.75 × Rv | Electrolytic | 0.78 | 6.1 | 86 | −3 | 52 |
| | | | polymerization | | | | | |
| R1 | 2.00 × Rv | 2.00 × Rv | Electrolytic | 0.77 | 6.6 | 112 | −2 | 36 |
| | | | polymerization | | | | | |
| B1 | 2.00 × Rv | 2.00 × Rv | Liquid dispersion | 0.43 | — | 100 | −77 | 64 |

As indicated in Table 2, for solid electrolytic capacitor R1, since the solid electrolyte layer was formed by three-pole electrolytic polymerization, a high initial capacitance was obtained, and the rate AC of change in capacitance after repeated charging and discharging was also kept low. However, since the average thickness of the dielectric layer was less than or equal to 2.5×Rv, the breakdown voltage remained low. In solid electrolytic capacitor B1 in which the solid electrolyte layer was formed using the liquid dispersion, while the breakdown voltage was high, capacitance dropped greatly after the repeated charging and discharging. By contrast, although solid electrolytic capacitors A1 and A2 had slightly lower initial capacities, compared with solid electrolytic capacitor B1, solid electrolytic capacitors A1 and A2 exhibited almost no change in capacitance after the repeated charging and discharging. Furthermore, the solid electrolytic capacitors A1 and A2 achieve breakdown voltages more than that of the solid electrolytic capacitor R1.

In solid electrolytic capacitor B1, because the characterizing peaks were not measured from the surface layer of the solid electrolyte layer either, it was not possible to obtain the ratio Iₚ₁/Iₚ₂ either, in the same manner as the first part. In the solid electrolytic capacitors A1 and A2, segregation of polymer anion was suppressed also in the surface layer of the solid electrolyte layer, in the same manner as the first part, and the ratio Iₚ₁/Iₚ₂ was substantially the same as that of the first part.

According to the present disclosure, it is possible to achieve a high withstand voltage as well as excellent charging and discharging characteristics. The solid electrolytic capacitor according to the present disclosure can maintain a high capacitance stably even when the solid electrolyte capacitor is charged and discharged repeatedly, and has a relatively high breakdown voltage. Therefore, the solid electrolytic capacitor can be used for various applications in which a high withstand voltage and reliability or a long life are required. However, the application of the solid electrolytic capacitor is not limited thereto.

What is claimed is:

1. A solid electrolytic capacitor comprising at least one capacitor element, wherein:
the at least one capacitor element includes:
an anode foil including a porous part on at least a surface layer of the anode foil;
a dielectric layer covering at least a part of the anode foil; and
a solid electrolyte layer covering at least a part of the dielectric layer,
the solid electrolyte layer includes a first polymer component containing a conjugated polymer and a second polymer component containing a polymer anion,
in a Raman spectrum of a surface layer of the solid electrolyte layer, a peak that is characteristic to the first polymer component is observed, and
an average thickness T (nm) of the dielectric layer is more than and equal to 2.50×Rv, where Rv (V) represents a rated voltage of the solid electrolytic capacitor.

2. The solid electrolytic capacitor according to claim 1, wherein:
the solid electrolyte layer contains sulfur element,
the anode foil contains aluminum element,
the solid electrolyte layer includes a first part and a second part, the first part filling voids of the porous part of the anode foil provided with the dielectric layer, the second part being disposed outside from a principal surface of the anode foil provided with the dielectric layer, and
in element mapping of a cross section of the porous part using an electron probe microanalyzer, an abundance ratio of sulfur element in the porous part is more than or equal to 0.5% in setting an abundance ratio of aluminum element in the porous part to be 100%.

3. The solid electrolytic capacitor according to claim 1, wherein the average thickness T (nm) of the dielectric layer is less than or equal to 3.50×Rv.

4. The solid electrolytic capacitor according to claim 1, wherein the rated voltage Rv is more than or equal to 12 V.

5. The solid electrolytic capacitor according to claim 1, wherein the conjugated polymer contains a monomer unit corresponding to a thiophene compound.

6. The solid electrolytic capacitor according to claim 5, wherein the peak that is characteristic to the first polymer component includes a first peak observed in a wavenumber range from 1200 cm⁻¹ to 1600 cm⁻¹, inclusive.

7. The solid electrolytic capacitor according to claim 5, wherein the first polymer component contains at least a monomer unit corresponding to a 3,4-ethylenedioxythiophene compound as the monomer unit corresponding to the thiophene compound.

8. The solid electrolytic capacitor according to claim 1, wherein a weight-average molecular weight of the polymer anion is in a range from 100 to 500,000, inclusive.

9. The solid electrolytic capacitor according to claim 1, wherein the polymer anion contains a monomer unit corresponding to an organic sulfonic acid compound.

10. The solid electrolytic capacitor according to claim 1, wherein:
the peak that is characteristic to the first polymer component includes a first peak observed in a wavenumber range from 1200 cm⁻¹ to 1600 cm⁻¹, inclusive,
the polymer anion contains a monomer unit corresponding to an aromatic sulfonic acid compound,
in the Raman spectrum of the surface layer of the solid electrolyte layer, a second peak that is characteristic to the second polymer component is observed in a wavenumber range from 800 cm⁻¹ to 1100 cm⁻¹, inclusive, and
a ratio Iₚ₁/Iₚ₂ of an intensity Iₚ₁ of the first peak to an intensity Iₚ₂ of the second peak is more than or equal to 2.

11. The solid electrolytic capacitor according to claim 2, wherein, in a Raman spectrum of the first part, a ratio Iₚ₁/Iₚ₂ of an intensity Iₚ₁ of the first peak that is characteristic to the first polymer component to an intensity Iₚ₂ of a second peak that is characteristic to the second polymer component is more than or equal to 2.

12. The solid electrolytic capacitor according to claim 1, comprising a plurality of capacitor elements stacked on top of one another, the plurality of capacitor elements including the at least one capacitor element.
